(19) United States
(12) Patent Application Publication
(10) Pub. No.: US 2014/0324868 A1
(43) Pub. Date: Oct. 30, 2014

(54) METHOD FOR RAPID DATA CLASSIFICATION

(71) Applicant: BORQS WIRELESS LTD., Beijing (CN)

(72) Inventors: Junjie LI, Beijing (CN); Wei ZOU, Beijing (CN); Jianbing LI, Beijing (CN)

(21) Appl. No.: 14/325,061

(22) Filed: Jul. 7, 2014

Related U.S. Application Data
(63) Continuation of application No. PCT/CN2012/083953, filed on Nov. 2, 2012.

(30) Foreign Application Priority Data
Mar. 15, 2012 (CN) 201210067760.5

(51) Int. Cl. G06F 17/30

(52) U.S. Cl. CPC G06F 17/30705
USPC 707/737

(57) ABSTRACT

A method for rapid data classification comprises selecting a data queue in which data with the same type is arranged adjacently. A starting point pointer, a middle point pointer, and an ending point pointer are enabled to point to a starting point, a middle point, and an ending point of the data queue, respectively. The method further comprises determining whether the types of the data pointed to by the starting point pointer and the middle point pointer are the same, and classifying the data with one type. The method further comprises enabling the starting point pointer to point to a starting position of a next type of the data, determining whether the types of the data pointed to by the starting point pointer and the middle point pointer are the same, and classifying the next type of data.

### CROSS-REFERENCE TO RELATED APPLICATIONS

This application is a continuation of International Patent Application No. PCT/CN2012/083953, filed on Nov. 2, 2012, which claims foreign priority from CN 201210067760.5, filed on Mar. 15, 2012, the disclosures of each of which are incorporated herein by reference in their entirety.

### BACKGROUND

1. Field

The present disclosure relates to a data processing method, and more particularly to a method for data classification.

2. Description of the Related Art

With the rapid development of database technology and wide application of database management systems, more and more data has been accumulated. Normally, since this data has a large number of corresponding attributes, it is impossible for all the information of the data to be recorded when used in a program. Thus, only the keyword queue of the data is recorded. The corresponding information is acquired according to the keyword during use. Data of the same type are adjacent in the queue. In the system, generally, data of different types are processed in different ways so as to be separated and put into different queues.

A common method for data classification includes: traversing the queue from the second data in the queue; acquiring data type information in sequence; comparing the information with the previous data type; continuing searching backward if the data types are the same; the data with different types are classified as one class, while the data with the same types as the first data are classified as one class.

The method for data classification described above has relatively large classification cost and relatively low efficiency of data queries when the amount of data is so large that the corresponding information is acquired with a certain cost by utilizing the keyword.

### SUMMARY

### Technical Problem

In order to overcome the deficiencies of the prior art, the present disclosure provides a method for quick data classification, which is directed to an identification (“ID”) queue, in which several types of data are recorded, data of the same type are arranged adjacently, and data of different types are classified into different queues. Technical Solution

In order to achieve the above purpose, the present disclosure provides a method for quick data classification, including the following steps.
1) selecting a data queue in which data of the same type are arranged adjacently;
2) determining whether the data pointed by a start pointer and the data pointed by a middle pointer in the queue are of the same type, and separating a type of data; and
3) making the start pointer point to the start position of the next type of data, determining whether the data pointed by the start pointer and the data pointed by the middle pointer are of the same type, and separating another type of data.

Among the above, said step 2) further includes the following steps: determining whether the data pointed by the start pointer and the data pointed by the middle pointer are of the same type; if the data pointed by the start pointer and the data pointed by the middle pointer are of the same type, making the start pointer point to the position of the middle pointer, and then making the middle pointer point to a new middle point; if the data pointed by the start pointer and the data pointed by the middle pointer are of different types, making the end pointer point to the position of the middle pointer, and then making the middle pointer point to a new middle point; and repeating the above steps until the start pointer points to the last position of this type of data.

Since the structure of the existing database tables is complex and the data amount is large, the information of the corresponding data can only be queried from the database according to an ID after acquiring the corresponding ID queue, which may need classification of data of different types. A certain amount of central processing unit (CPU) resources is consumed for querying the database, and thus the times of database queries may be minimized. As compared to the existing method, the method for classifying data of embodiments of the present disclosure has the advantages of low cost and high efficiency and reduced times of database queries.

Other features and advantages of the present disclosure will be described in the following description, and will partly become apparent from the description, or will be recognized by implementing the present disclosure.

### BRIEF DESCRIPTION OF THE DRAWINGS

The accompanying drawings are used to provide a further understanding of the present disclosure and constitute a part of the description. The drawings together with the contents and embodiments of the present disclosure are used to explain the present disclosure without limitation, in which:

FIG. 1 is a flow diagram of a method for quick data classification according to the present disclosure.

FIG. 2 is a flow diagram of a method for separating a type of data according to the present disclosure.

FIG. 3 is a block diagram of a computing system that implements the methods of FIGS. 1 and 2.

### DETAILED DESCRIPTION

The preferred embodiments of the present disclosure are described below in conjunction with the accompanying drawings. It should be understood that the embodiments described herein are only used for illustrating and explaining the present disclosure, and not for limitation of the present disclosure.

In the case of a very large amount of data, only the ID of the data is recorded for recording data, and the data then can be accessed according to the ID.

The main object of the method is an ID queue, in which several types of data are recorded, and data of the same type are arranged adjacently, such as {{83 55 76 90 89 82} {1 23 12 8} {122 100} . . . }, for the purpose of classifying data of different types into different queues.

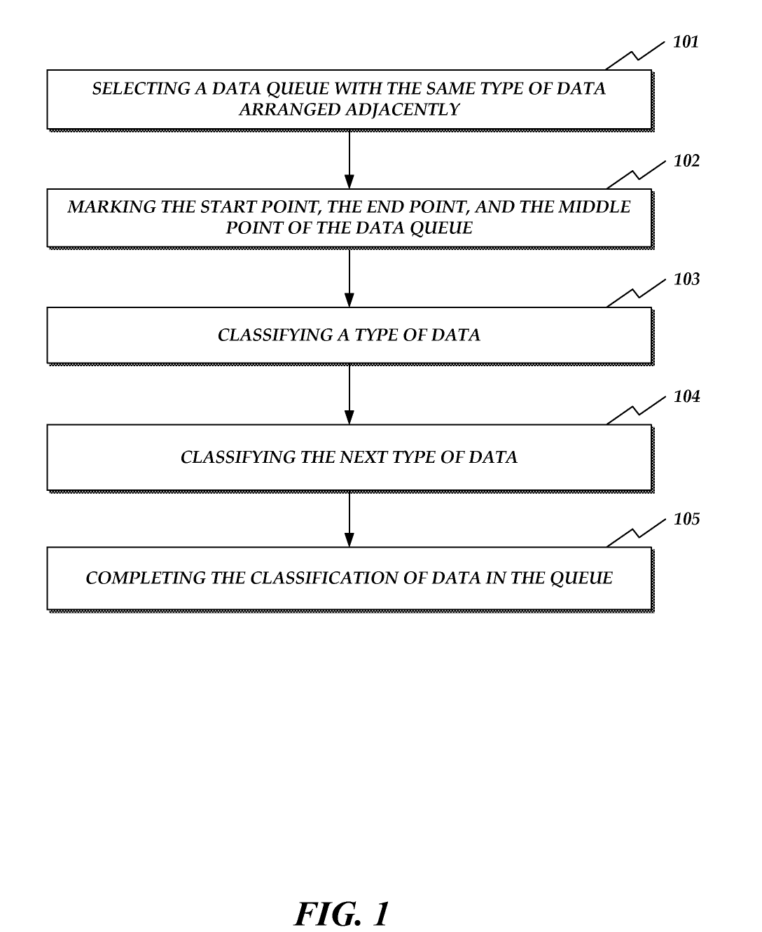

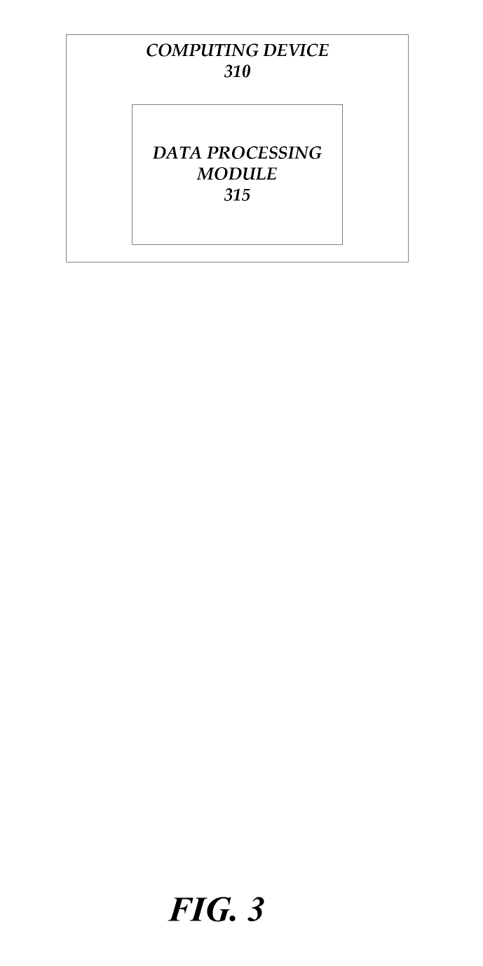

FIG. 1 is a flow diagram of a method for quick data classification according to the present disclosure. The method of FIG. 1 can be implemented by a computing device, such as the computing device 310 described with respect to FIG. 3 below. The method for quick data classification of the present disclosure will be described in detail below with reference to FIG. 1.

First, at step 101, a data queue is selected, which has various different types of data, and data of the same type are arranged adjacently.

At step 102, a start pointer (start), a middle pointer (middle) and an end pointer (end) of the queue are set and point to the start point, the middle point and the end point of the queue respectively, in which start=the start point of the queue, end=the end point of the queue, and middle=(start+end)/2.

At step 103, a type of data is separated from the start point of the queue through the use of the start pointer, middle pointer, and end pointer.

At step 104, the start pointer (start) points to the start position of the next type of data, and step 103 is repeated to separate another type of data.

At step 105, steps 103 and 104 are repeated to separate all the data in the queue in sequence.

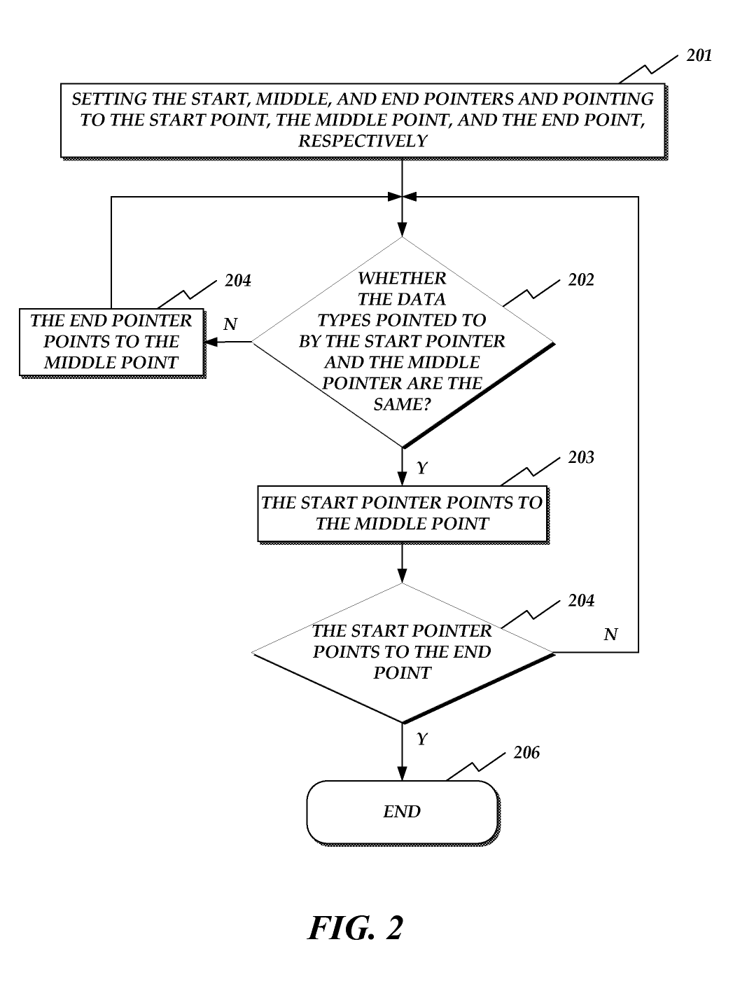

FIG. 2 is a flow diagram of a method for separating a type of data according to the present disclosure. The method of FIG. 2 can be implemented by computing device, such as the computing device 310 described with respect to FIG. 3 below. The method for quick data classification of the present disclosure will be described in detail below with reference to FIG. 2.

First, at step 201, the start pointer (start), the middle pointer (middle), and the end pointer (end) point to the start point, the middle point and the end point of the queue respectively, in which start=the start point of the queue, end=the end point of the queue, and middle=(start+end)/2.

At step 202, whether the data pointed by the start pointer and the data pointed by the middle pointer are of the same type is determined. If the types are the same, the next step is executed; otherwise, the method proceeds to step 204.

At step 203, the start pointer points to the middle point, and the method proceeds to step 205 for processing.

At step 204, the end pointer points to the middle point, and the method proceeds to step 202 for processing.

At step 205, whether the start pointer points to the last position of the type of data (start=end−1) is determined. If the start pointer points to the last position of the type of data, the method proceeds to the next step; otherwise, the method proceeds to step 202 for processing.

At step 206, all the data in the queue is separated and the data classification is completed.

In accordance with embodiments of a method of the present disclosure, first find out a type of data in the queue, then set three pointers (start, end, and middle) for respectively identifying the start point, the end point, and the middle point of the type of data. Start=step; end =the end point of the queue; and middle=(start+end)/2.

The method, or process, may include checking the start point and the middle point to determine whether they point to data of the same type. If they point to data of the same type, start=middle; otherwise, end=middle; and middle=(start+end)/2. The process is repeated until start=end−1. Then the start pointer points to the last position of this type of data, and the end pointer points to the start position of the next type of data. The data between “step” and “start” is the first type of data that should be found, thus a type of data is separated. The above steps are repeated to quickly classify the data in the queue.

FIG. 3 is a block diagram of a computing device 310 that implements the methods of FIGS. 1 and 2. In an embodiment, the computing device 310 is an electronic device that includes various hardware components. For example, the computing device 310 may include a database processing module 315 that is configured to implement the methods of FIGS. 1 and 2. The database processing module 315 may further include one or more CPUs to implement the methods of FIGS. 1 and 2. While FIG. 3 illustrates the database processing module 315 comprised within one computing device 310, this is not meant to be limiting. The database processing module 315 may be implemented by one or more computing devices.

It can be understood by the person of skill in the art that the above are just preferred embodiments of the present disclosure and are not used for limiting the present disclosure. Although the present disclosure has been illustrated in detail with reference to the above embodiments, modifications to the technical solution recited in the embodiments described above or equivalent alterations to part of the technical features may also be made by the person skilled in the art. Any modifications, equivalent alterations, and improvements and the like within the spirit and principle of the present invention should be included in the protection scope of the present disclosure.

Many other variations than those described herein will be apparent from this disclosure. For example, depending on the embodiment, certain acts, events, or functions of any of the algorithms described herein can be performed in a different sequence, can be added, merged, or left out all together (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. A computing environment can include any type of computer system, including, but not limited to, a computer system based on a microprocessor, a mainframe computer, a digital signal processor, a portable computing device, a personal organizer, a device controller, and a computational engine within an appliance, to name a few.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others.

What is claimed is:

1. A method for quick data classification, the method comprising:
selecting a data queue in which data of a first type are arranged adjacently, wherein the data queue includes a start point, a middle point, and an end point;
causing a start pointer to point to the start point, a middle pointer to point to the middle point, and an end pointer to point to the end point;
determining whether data pointed to by the start pointer and data pointed to by the middle pointer are both of the first type;
separating the first type of data;
causing the start pointer to point to a start position of a second type of data;
determining whether the data pointed to by the start pointer and the data pointed to by the middle pointer are of the second type; and
separating the second type of data.

2. The method of claim 1, wherein causing a start pointer to point to the start point further comprises:
determining whether the data pointed to by the start pointer and the data pointed to by the middle pointer are both of the first data type;
in connection with a determination that the data pointed to by the start pointer and the data pointed to by the middle pointer are both of the first type, causing the start pointer to point to a position of the middle pointer and the middle pointer to point to a new middle point between the position of the middle pointer and a position of the end pointer;
in connection with a determination that the data pointed to by the start pointer and the data pointed to by the middle pointer are not both of the first type, causing the end pointer to point to the position of the middle pointer and the middle pointer to point to a new middle point between a position of the first pointer and the position of the middle pointer; and
repeating the determining whether the data point to by the start point and the data point to by the middle pointer are of the same type, the causing the start pointer to point to the position of the middle pointer, and the causing the end point to point to the position of the middle pointer until the start pointer points to a last position of the first type of data.
